(19) United States
(12) Patent Application Publication
(10) Pub. No.: US 2018/0084346 A1
(43) Pub. Date: Mar. 22, 2018

(54) PLANAR SPEAKER UNIT

(71) Applicant: Bill Yang, Taipei City (TW)

(72) Inventor: Bill Yang, Taipei City (TW)

(73) Assignee: Cotron Corporation, Taipei City (TW)

(21) Appl. No.: 15/475,135

(22) Filed: Mar. 31, 2017

(30) Foreign Application Priority Data
Sep. 20, 2016 (TW) 105130339

(51) Int. Cl. H04R 9/06; H04R 7/04; H04R 7/18; H04R 9/02; H04R 1/06; H04R 1/28; H04R 9/04

(52) U.S. Cl. CPC H04R 9/06; H04R 7/04; H04R 7/18; H04R 9/047; H04R 1/06; H04R 1/288; H04R 9/025

(57) ABSTRACT

A planar speaker unit including a housing, a first magnet set, and a diaphragm is provided. The housing has an accommodating space and a bottom wall. The first magnet set is disposed on the bottom wall and located in the accommodating space. The diaphragm is disposed in the accommodating space and located above the first magnet set. The diaphragm includes a substrate and a planar coil. The planar coil is flatly attached on the substrate. The maximum vibration amplitude of the diaphragm is smaller than the minimum distance between the diaphragm and the first magnet set. The diaphragm is tension-free.

### CROSS REFERENCE TO RELATED APPLICATION

This application claims the priority benefits of Taiwan application serial no. 105130339, filed on Sep. 20, 2016. The entirety of the above-mentioned patent application is hereby incorporated by reference herein and made a part of specification.

### BACKGROUND OF THE INVENTION

### Field of the Invention

The invention relates to a speaker unit, and more particularly, to a planar speaker unit.

### Description of Related Art

With the continuous progress of technology, electronic products are all being developed to be lightweight, and even the size of speakers is getting smaller, and planar speakers have even been developed. In the traditional stereo coil speaker unit, the coil is generally wounded into the shape of a ring side by side, and a side thereof is attached to the center of the diaphragm to drive the diaphragm to vibrate and generate sound. In the traditional planar speaker, the coil is flatly attached to the diaphragm and distributed in an S shape, and a plurality of magnets parallel to one another is correspondingly disposed. However, since the coil is distributed on the diaphragm in an S shape, the number of windings thereof is limited by the area of the diaphragm and cannot be too large, such that the electromagnetic drive force produced between the coil and the magnet is far less than that of the traditional stereo coil speaker unit. To solve the issue of limited vibration amplitude of the diaphragm due to insufficient electromagnetic drive force and the resulting insufficient bass, the traditional planar speaker can only adopt a very thin diaphragm to increase the vibration amplitude. However, when the thickness of the diaphragm is reduced, the issue of insufficient hardness of the diaphragm causing the diaphragm to deform and touch the magnet when the coil is not driven is produced. Therefore, the diaphragm of the traditional planar speaker needs to be stretched tightly first and then fixed on a fixed ring. As a result, the bass performance of the traditional planar speaker is further reduced.

### SUMMARY OF THE INVENTION

The invention provides a planar speaker unit that can solve the issue of poor sound performance of the traditional planar speaker unit.

The planar speaker unit of the invention includes a housing, a first magnet set, and a diaphragm. The housing has an accommodating space and a bottom wall. The first magnet set is disposed on the bottom wall and located in the accommodating space. The diaphragm is disposed in the accommodating space and located above the first magnet set. The diaphragm includes a substrate and a planar coil. The planar coil is flatly attached to the substrate. The maximum vibration amplitude of the diaphragm is smaller than the minimum distance between the diaphragm and the first magnet set. The diaphragm is tension-free.

In an embodiment of the invention, the substrate has a wiring plane. The planar coil is flatly attached to the wiring plane of the substrate by being parallel to the wiring plane.

In an embodiment of the invention, the first magnet set includes a center magnet and a ring magnet surrounding the center magnet. The center magnet and the ring magnet are disposed as magnetic pole opposites, the magnetic field line between the center magnet and the ring magnet passes through the diaphragm, and the magnetic pole connection of the center magnet and the magnetic pole connection of the ring magnet pass through the diaphragm.

In an embodiment of the invention, the planar coil is distributed in a central area and a ring area surrounding the central area. The orthographic projection of the ring magnet on the diaphragm is located between the central area and the ring area.

In an embodiment of the invention, the first magnet set includes a center magnet and a plurality of ring magnets. The ring magnets surround the center magnet and are disposed as concentric circles. The center magnet and the ring magnets are disposed as magnetic pole opposites, the magnetic field lines between the center magnet and the ring magnets passes through the diaphragm, and the magnetic pole connection of the center magnet and the magnetic pole connections of the ring magnets pass through the diaphragm.

In an embodiment of the invention, the planar coil is distributed in a central area and a plurality of ring areas. The ring areas surround the central area and are disposed as concentric circles. The orthographic projection of each of the ring magnets on the diaphragm is located between the central area and one of the ring areas or between two adjacent ring areas.

In an embodiment of the invention, the minimum distance between the diaphragm and the first magnet set is less than or equal to 2 mm.

In an embodiment of the invention, the planar speaker unit further includes a fastener disposed in the housing. The outer edge of the diaphragm is limited between the fastener and the housing.

In an embodiment of the invention, the fastener is fixed to the outer edge of the diaphragm.

In an embodiment of the invention, the outer edge of the diaphragm can move relative to the fastener and the housing.

In an embodiment of the invention, the planar coil is single-turn.

In an embodiment of the invention, the planar coil is multi-turn and parallel to each other.

In an embodiment of the invention, the housing further has a top wall, and the bottom wall and the top wall are located at two opposite sides of the accommodating space.

In an embodiment of the invention, the material of the top wall is a non-magnetic permeable material.

In an embodiment of the invention, the planar speaker unit further includes a second magnet set disposed on the top wall and located in the accommodating space. The diaphragm is located between the first magnet set and the second magnet set. The maximum vibration amplitude of the diaphragm is smaller than the minimum distance between the diaphragm and the second magnet set.

In an embodiment of the invention, the material of the substrate is polyimide.

In an embodiment of the invention, the planar coil is flatly attached to both sides of the substrate.

In an embodiment of the invention, the substrate includes a coil area, a connection area, and a power supplying area, and the connection area is connected between the coil area and the power supplying area. The planar coil is extended from the coil area to the power supplying area via the connection area, and the two ends of the planar coil are two contacts located in the power supplying area. The entire planar coil is formed by a homogeneous conductor having uniform thickness.

In an embodiment of the invention, the coil area is located in the accommodating space, the connection area is bent and extended outside the accommodating space, and the power supplying area and the coil area are respectively located at two sides of the bottom wall.

In an embodiment of the invention, the material of the bottom wall is a magnetic permeable material.

In an embodiment of the invention, the substrate has a plurality of hollow areas surrounding the planar coil.

In an embodiment of the invention, the planar speaker unit further includes a suspension member disposed on the substrate and across at least one of the hollow areas.

In an embodiment of the invention, the center of the bottom wall has a first ventilation hole, the first magnet set has a second ventilation hole, and the first ventilation hole is communicated with the second ventilation hole.

In an embodiment of the invention, the thickness of the substrate is greater than or equal to 2 mm.

In an embodiment of the invention, the diaphragm further includes a damping layer covering the substrate and the planar coil to protect the planar coil from oxidation and to absorb the resonance of the diaphragm.

In an embodiment of the invention, the material of the damping layer is epoxy resin.

In an embodiment of the invention, the diaphragm further comprises a dummy pattern disposed on the substrate except where the planar coil is distributed.

In an embodiment of the invention, the dummy pattern and the planar coil are made from the same material and insulated from each other.

In an embodiment of the invention, the dummy pattern comprises a plurality of strips being distributed radially.

Based on the above, in the planar speaker unit of the invention, the maximum vibration amplitude of the diaphragm is less than the minimum distance between the diaphragm the first magnet set, and the diaphragm is tension-free, and therefore tension does not need to be applied to the diaphragm beforehand to prevent contact between the diaphragm and the first magnet set, and as result sound performance is not affected.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional schematic diagram of a planar speaker unit of an embodiment of the invention.

FIG. 2A is a schematic diagram of the relative positions of the diaphragm of the planar speaker unit of FIG. 1 in flattened state and the first magnet set.

FIG. 2B is a cross-sectional schematic of a portion of the diaphragm of FIG. 2A.

FIG. 3 is a schematic diagram of the upper surface of the diaphragm of FIG. 2A.

FIG. 4 is a schematic diagram of the lower surface of the diaphragm of FIG. 2A.

FIG. 5 is a top view of the planar speaker unit of FIG. 1.

FIG. 6 is a bottom view of the planar speaker unit of FIG. 1.

FIG. 7 is a cross-sectional schematic diagram of a planar speaker unit of another embodiment of the invention.

FIG. 8 is a schematic diagram of the relative positions of the diaphragm of the planar speaker unit of yet another embodiment of the invention in flattened state and the first magnet set.

### DESCRIPTION OF THE EMBODIMENTS

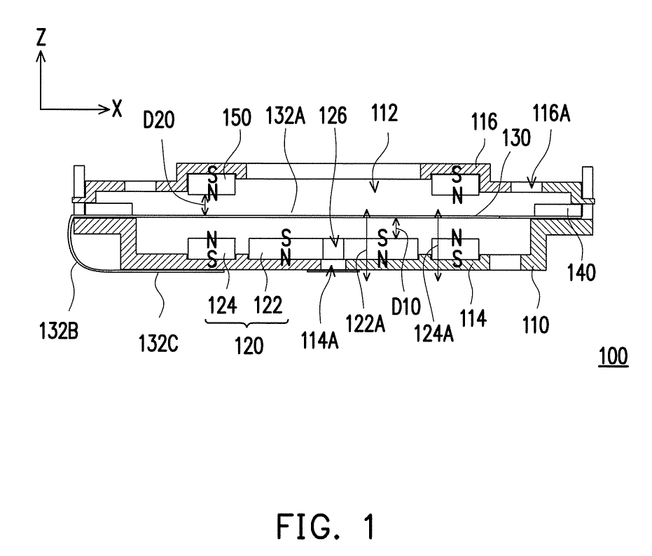

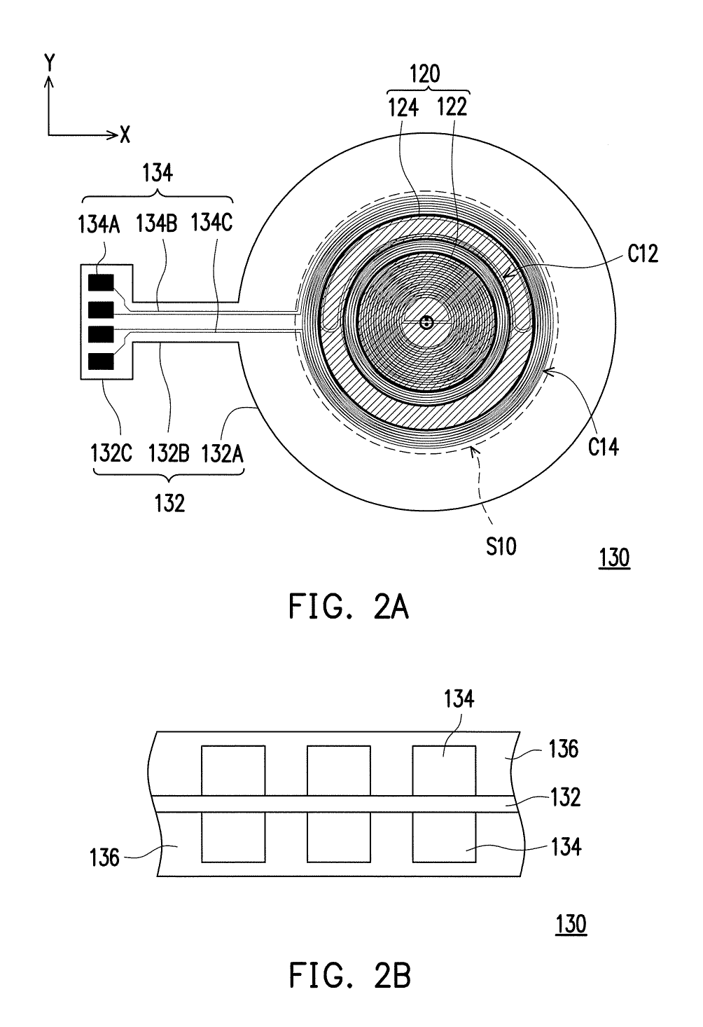

FIG. 1 is a cross-sectional schematic diagram of a planar speaker unit of an embodiment of the invention, and FIG. 2A is a schematic diagram of the relative positions of the diaphragm of the planar speaker unit of FIG. 1 in flattened state and the first magnet set. Referring to FIG. 1 and FIG. 2A, a planar speaker unit 100 of the present embodiment includes a housing 110, a first magnet set 120, and a diaphragm 130. The housing 110 has an accommodating space 112 and a bottom wall 114. The first magnet set 120 is disposed on the bottom wall 114 and located in the accommodating space 112. The diaphragm 130 is disposed in the accommodating space 112 and located above the first magnet set 120. The diaphragm 130 includes a substrate 132 and a planar coil 134. The planar coil 134 is flatly attached to the substrate 132. Due to the thickness ratio, FIG. 1 does not clearly show the planar coil 134. Please refer to FIG. 2A. The maximum vibration amplitude of the diaphragm 130 is smaller than a minimum distance D10 between the diaphragm 130 and the first magnet set 120. Moreover, the diaphragm 130 is tension-free, i.e., no tension is applied to the diaphragm 130 beforehand.

In the planar speaker unit 100 of the present embodiment, since the maximum vibration amplitude of the diaphragm 130 is less than the minimum distance D10 between the diaphragm 130 and the first magnet set 120, the diaphragm 130 is not in contact with the first magnet set 120 when driven by electromagnetic force to vibrate and generate sound, and therefore reduced sound quality caused by compromised vibration of the diaphragm 130 can be prevented. In comparison to the known planar speaker unit, the planar speaker unit 100 of the present embodiment has reliable sound quality. It should be mentioned here that, the planar coil 134 is flatly attached to the substrate 132 means that the planar coil 134 is circuitously arranged on and attached to the substrate 132 by being parallel to the surface of the substrate 132, and the portion of the planar coil 134 on the same surface of the substrate 132 is substantially not overlapped. On the other hand, the coil of the stereo coil speaker unit is wounded and stacked as a ring and a side thereof is attached to the center of the diaphragm, and therefore the projection of the coil on the diaphragm is substantially completely overlapped. Since the planar coil 134 of the present embodiment is flatly attached to the substrate 132, the overall thickness of the planar speaker unit 100 can be reduced. Moreover, the diaphragm 130 of the present embodiment is tension-free, and a fixed ring is not needed to tighten the diaphragm as is the case in the prior art, and therefore the diaphragm 130 can have a greater vibration amplitude to increase bass performance, and the process of tightening the diaphragm is omitted.

The substrate 132 of the present embodiment has, for instance, a wiring plane S10. In other words, as observed in the state of FIG. 1, the wiring plane S10 is substantially a flat surface with no rise and fall as a whole, which is different from the diaphragm of the known stereo coil speaker that generally has rise and fall formed by a plurality of concentric arcs. The planar coil 134 is flatly attached to the wiring plane S10 of the substrate 132 by being parallel to the wiring plane S10. In the present embodiment, the entire planar coil 134 is substantially located on a flat surface parallel to the XY plane, and the entire wiring plane S10 is also located on a flat surface parallel to the XY plane. The first magnet set 120 of the present embodiment includes a center magnet 122 and a ring magnet 124 surrounding the center magnet 122. The center magnet 122 and the ring magnet 124 are disposed as magnetic pole opposites, the magnetic field line between the center magnet 122 and the ring magnet 124 passes through the diaphragm 130, and a magnetic pole connection 122A of the center magnet 122 and a magnetic pole connection 124A of the ring magnet 124 pass through the diaphragm 130. Specifically, the S pole of the center magnet 122 faces the diaphragm 130 and the N pole of the ring magnet 124 faces the diaphragm 130. Therefore, the magnetic field line between the center magnet 122 and the ring magnet 124 can pass through the planar coil 134 on the diaphragm 130 in a direction substantially parallel to the diaphragm 130. After the magnetic field produced by powering on the planar coil 134 interacts with the magnetic field line between the center magnet 122 and the ring magnet 124, the diaphragm 130 produces vibration in the Z direction.

The planar coil 134 of the present embodiment is distributed in a central area C12 and a ring area C14 surrounding the central area C12. The orthographic projection of the ring magnet 124 on the diaphragm 130 is located between the central area C12 and the ring area C14. The planar coil 134 is substantially not distributed above the center of the ring magnet 124 because the magnetic field line above the center of the ring magnet 124 passes through the planar coil 134 in a direction substantially perpendicular to the diaphragm 130, and the direction of the resulting electromagnetic force cannot drive the vibration of the diaphragm 130 in the Z direction. The center magnet 122 and the central area C12 of the present embodiment are, for instance, in the shape of a round cake, and the ring magnet 124 and the ring area C14 are, for instance, round ring-shaped, but the invention is not limited thereto. Since the planar coil 134 of the present embodiment adopts a ring-shaped surround wiring method, in comparison to the S-shaped distribution of the coil of the known planar speaker, a wiring method with more windings can be more readily designed for the planar coil 134 of the present embodiment, and therefore a greater magnetic power can be provided to drive the diaphragm 130. When the driving force produced by the planar coil 134 is greater, a diaphragm 130 having a thicker substrate 132 can be adopted, and contact between the diaphragm 130 and the first magnet set 120 during vibration and sound emission is readily prevented. Moreover, by adopting the diaphragm 130 having a thicker substrate 132, the diaphragm does not need to be tightened as in the prior art, and therefore the diaphragm 130 can have a greater vibration amplitude such that bass performance is increased, and the process of tightening the diaphragm is omitted.

FIG. 2B is a cross-sectional schematic of a portion of the diaphragm of FIG. 2A. The material of the substrate 132 of the present embodiment is polyimide, but the invention is not limited thereto. The thickness of the substrate 132 is, for instance, greater than or equal to 2 μm. Specifically, the substrate 132 can adopt the same material as the general flexible circuit board and adopt a mature technique in the field of flexible circuit boards to form the planar coil 134 on the substrate 132, such as printing, sputtering, and vapor deposition. Moreover, after the planar coil 134 is formed on the substrate 132, a damping layer 136 covering the surface of the substrate 132 can further be formed, and the damping layer 136 can also cover the surface of the planar coil 134 to protect the planar coil 134 from oxidation and can also be used to absorb the resonance of the diaphragm 130. The material of the damping layer 136 is, for instance, epoxy resin. Since the flexible circuit board is a technically-mature product, using a flexible circuit board as the diaphragm 130 can significantly reduce the manufacturing cost of the diaphragm 130 and increase the yield thereof. The substrate 132 of the present embodiment includes, for instance, a coil area 132A, a connection area 132B, and a power supplying area 132C. The connection area 132B is connected between the coil area 132A and the power supplying area 132C. The planar coil 134 is extended from the coil area 132A to the power supplying area 132C via the connection area 132B, and the two ends of the planar coil 134 are two contacts 134A located in the power supplying area 132C. The contacts 134A are used for outward connection to receive an externally-inputted drive current. In the present embodiment, the entire planar coil 134 is formed by a homogeneous conductor having uniform thickness, i.e., the planar coil 134 does not have additional solder joints or other heterogeneous junctions in the coil area 132A, the connection area 132B, or the power supplying area 132C. The planar coil 134 is, for instance, formed by a copper layer having a thickness of 12.5 μm. Since the entire planar coil 134 is formed by a homogeneous conductor, compromised vibration of the diaphragm 130 by heterogeneous junctions can be substantially avoided so as to ensure sound performance.

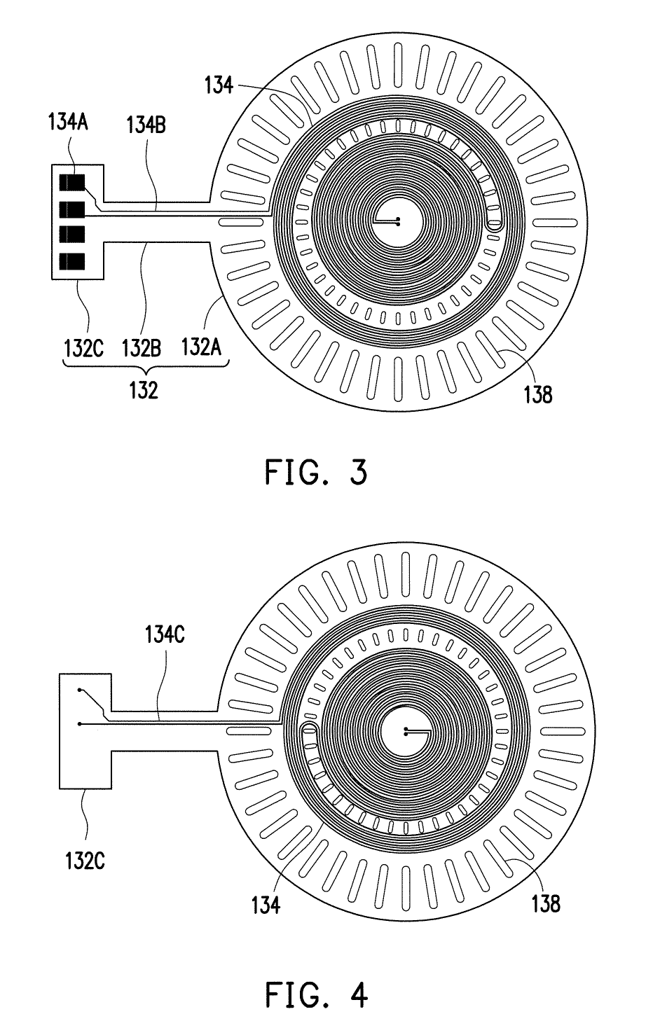

As shown in FIG. 1, the housing 110 of the present embodiment can further have a top wall 116. The bottom wall 114 and the top wall 116 are located at two opposite sides of the accommodating space 112. The coil area 132A is located in the accommodating space 112, the connection area 132B is bent and extended outside the accommodating space 112, and the power supplying area 132C and the coil area 132A are respectively located at two sides of the bottom wall 114. In other words, the power supplying area 132C and the coil area 132A are respectively located inside and outside the housing 110 and are connected by the connection area 132B. FIG. 3 and FIG. 4 are respectively schematic diagrams of the upper surface and the lower surface of the diaphragm of FIG. 1. Referring to FIG. 2A to FIG. 4, the planar coil 134 of the present embodiment is flatly attached to both sides of the substrate 132. Specifically, a first portion 134B of the planar coil 134 passes through the substrate 132 after surrounding the center on the upper surface of the substrate 132, and then a second portion 134C of the planar coil 134 surrounds the center outwardly on the lower surface of the substrate 132 and is extended to the power supplying area 132C. Since both sides of the substrate 132 are used, the planar coil 134 can be designed to have more windings to provide greater magnetic power to drive the diaphragm 130. Moreover, the planar coil 134 of the present embodiment is exemplified to include two turns parallel to each other, but the planar coil 134 of the invention can also be single-turn or have more turns.

Referring further to FIG. 1, in the present embodiment, the minimum distance D10 between the diaphragm 130 and the first magnet set 120 is, for instance, less than or equal to 2 mm or less than or equal to 1 mm. The planar speaker unit 100 of the present embodiment can further include a fastener 140 disposed in the housing 110. The outer edge of the diaphragm 130 is limited between the fastener 140 and the housing 110. The fastener 140 of the present embodiment is used to fix the outer edge of the diaphragm 130, i.e., the fastener 140 and the diaphragm 130 can be combined by glue or other methods. The planar speaker unit 100 of the present embodiment can further include a second magnet set 150 disposed on the top wall 116 and located in the accommodating space 112. The diaphragm 130 is located between the first magnet set 120 and the second magnet set 150. The maximum vibration amplitude of the diaphragm 130 is smaller than a minimum distance D20 between the diaphragm 130 and the second magnet set 150. A greater magnetic power can be provided by adding the second magnet set 150 to drive the diaphragm 130. The first magnet set 120 and the second magnet set 150 are also disposed as magnetic pole opposites, and therefore a buckle structure can be provided between the bottom all 114 and the top wall 116 to fix the relative positions of the first magnet set 120 and the second magnet set 150. The material of the bottom wall 114 of the present embodiment is a magnetic permeable material, such as metal or other suitable materials, but the invention is not limited thereto. The material of the top wall 116 of the present embodiment is a non-magnetic permeable material, such as plastic or other suitable materials, but the invention is not limited thereto.

Referring to FIGS. 3 and 4, the diaphragm 130 of the embodiment further comprises a dummy pattern 138 disposed on the substrate 132 except where the planar coil 134 is distributed. The dummy pattern 138 is omitted in FIG. 2 for the purpose of clearly showing the relative positions of the planar coil 134, the center magnet 122 and the ring magnet 124. The dummy pattern 138 facilitates the diaphragm 130 having the uniform stiffness, so that the diaphragm 130 provides better frequency response curve. The dummy pattern 138 and the planar coil 134 could be made from the same material and insulated from each other. Additional process for forming the dummy pattern 138 is unnecessary. The dummy pattern 138 comprises a plurality of strips being distributed radially as shown in FIGS. 3 and 4, but the present invention is not limited thereto.

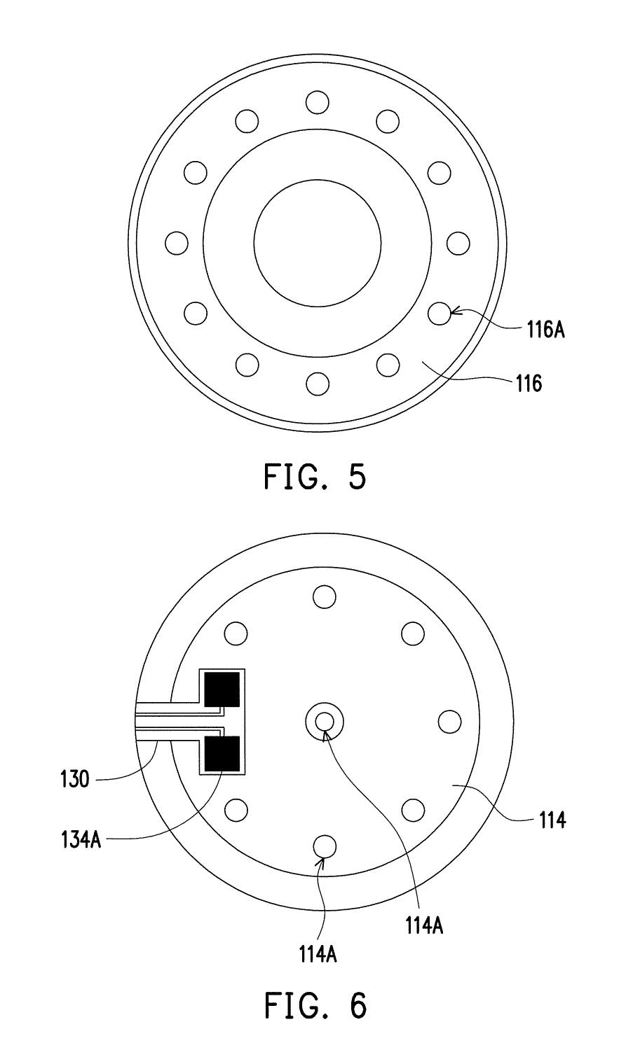

FIG. 5 and FIG. 6 are respectively top and bottom views of the planar speaker unit of FIG. 1. Referring to FIG. 1, FIG. 5, and FIG. 6, the top wall 116 of the present embodiment has a plurality of third ventilation holes 116A. The center of the bottom wall 114 has a first ventilation hole 114A. The first magnet set 120 has a second ventilation hole 126. The first ventilation hole 114A is communicated with the second ventilation hole 126. By disposing the ventilation holes 114A, 126, and 116A, the accommodating space 112 can be prevented from becoming an enclosed space, and as a result, the diaphragm 130 can be ensured to have better vibration effects so as to provide better sound quality.

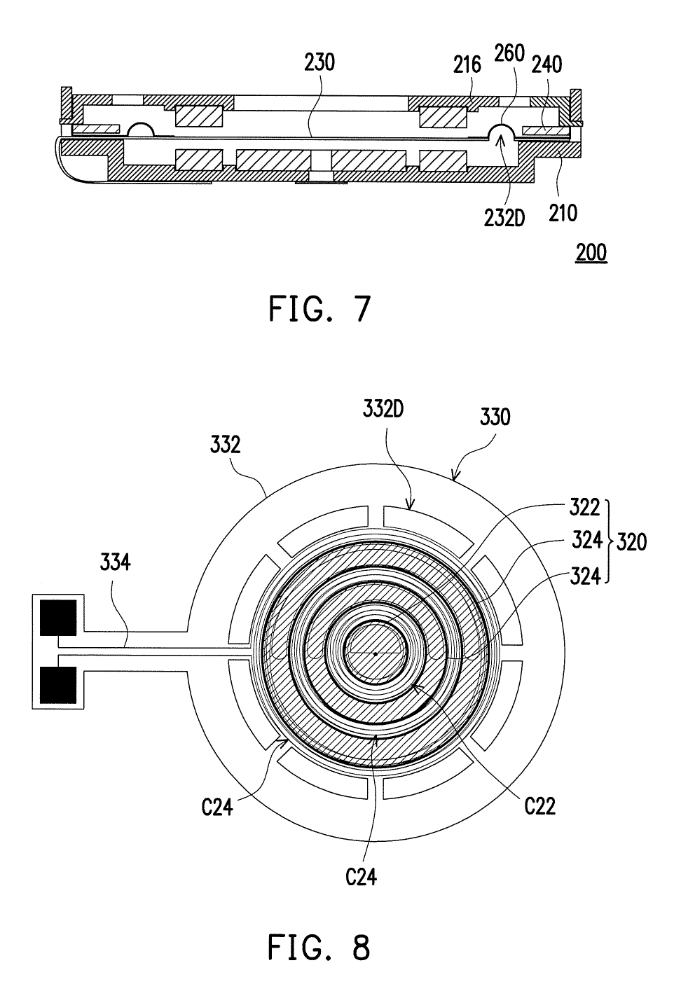

FIG. 7 is a cross-sectional schematic diagram of a planar speaker unit of another embodiment of the invention. Referring to FIG. 7, a planar speaker unit 200 of the present embodiment is similar to the planar speaker unit 100 of FIG. 1, and only the differences of the two are described herein. The outer edge of a diaphragm 230 of the present embodiment can move relative to a fastener 240 and a housing 210. In other words, neither the fastener 240 nor the housing 210 is fixedly combined to the outer edge of the diaphragm 230. Therefore, the diaphragm 230 has a greater degree of freedom to vibrate, and therefore bass quality can be increased. Moreover, the top wall 116 of FIG. 1 has bumps corresponding to the second magnet set 150, and the top wall 216 of FIG. 7 is substantially planar. The substrate of the diaphragm 230 of the present embodiment has a plurality of hollow areas 232D, and therefore the degree of freedom of the diaphragm 230 during vibration can be increased. The hollow areas 232D in FIG. 7 are not covered by the fastener 240. However, in the embodiments not shown, the hollow areas 232D could be covered by the fastener 240 partially, but the hollow areas 232D should not be covered by the fastener 240 completely. Moreover, the planar speaker unit 200 of the present embodiment can further include a suspension member 260 disposed on the substrate of the diaphragm 230 and across at least one of the hollow areas 232D. The suspension member 260 allows the diaphragm 230 to maintain the degree of freedom provided by the hollow areas 232D during vibration and allows the diaphragm 230 to have sufficient strength so that the diaphragm 230 is not readily damaged. The material of the suspension member 260 can be thermoplastic elastomer (TPE), polyethylene terephthalate (PET) or other suitable materials. The suspension member 260 of FIG. 7 has an arc-shape, but the suspension member 260 could be planar, the present invention is not limited thereto.

FIG. 8 is a schematic diagram of the relative positions of the diaphragm of the planar speaker unit of yet another embodiment of the invention in flattened state and the first magnet set. Referring to FIG. 8, a diaphragm 330 and a first magnet set 320 of the planar speaker unit of the present embodiment are similar to the diaphragm 130 and the first magnet set 120 of the planar speaker unit 100 of FIG. 1, and only the differences of the two are described herein. The first magnet set 320 of the present embodiment includes a center magnet 322 and a plurality of ring magnets 324. The plurality of ring magnets 324 surround the center magnet 322 and are disposed as concentric circles. The center magnet 322 and the nearest ring magnet 324 are disposed as magnetic pole opposites, and two adjacent ring magnets 324 are also disposed as magnetic pole opposites. Similar to FIG. 1, the magnetic pole connection of the center magnet 322 and the magnetic pole connections of the ring magnets 324 pass through the diaphragm 330 and the magnetic field lines between the center magnet 322 and the ring magnets 324 passes through the diaphragm 330. A planar coil 334 of the present embodiment is distributed in a central area C22 and a plurality of ring areas C24. The ring areas C24 surround the central area C22 and are disposed as concentric circles. The orthographic projection of one of the ring magnets 324 on the diaphragm 330 is located between the central area C22 and an adjacent ring area C24, and the orthographic projection of the other ring magnet 324 on the diaphragm 330 is located between two adjacent ring areas C24. The design principle of the relative positions of the first magnet set 320 and the planar coil 334 is similar to that of FIG. 1. The planar coil 334 of the present embodiment is single-turn, which is different from the two-turn planar coil 134 of FIG. 1. Moreover, the substrate 332 of the diaphragm 330 of the present embodiment has a plurality of hollow areas 332D surrounding the planar coil 334, and therefore the degree of freedom of the diaphragm 330 during vibration can be increased. The suspension member 260 of FIG. 7 can also be applied in the embodiment of FIG. 8, i.e., the suspension member 260 can be disposed on the substrate 332 and across at least one of the hollow areas 332D. The relationship between the quantities of the suspension member and the hollow areas can be a single suspension member corresponding to a plurality of hollow areas or a plurality of suspension members corresponding to a plurality of hollow area.

Based on the above, in the planar speaker unit of the invention, by making the maximum vibration amplitude of the diaphragm less than the minimum distance between the diaphragm and the first magnet set, contact between the diaphragm and the first magnet set is prevented, such that the sound performance of the planar speaker unit is not compromised. Moreover, a flexible circuit board can optionally be used as a diaphragm. As a result, not only can bass performance be increased, the manufacturing process can be simplified and manufacturing costs can be significantly reduced.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A planar speaker unit, comprising:
a housing having an accommodating space and a bottom wall;
a first magnet set disposed on the bottom wall and located in the accommodating space; and
a diaphragm disposed in the accommodating space and located above the first magnet set, wherein the diaphragm comprises a substrate and a planar coil, the planar coil is flatly attached to the substrate, a maximum vibration amplitude of the diaphragm is less than a minimum distance between the diaphragm and the first magnet set, and the diaphragm is tension-free.

2. The planar speaker unit of claim 1, wherein the substrate has a wiring plane, and the planar coil is flatly attached to the wiring plane of the substrate by being parallel to the wiring plane.

3. The planar speaker unit of claim 1, wherein the first magnet set comprises a center magnet and a ring magnet surrounding the center magnet, the center magnet and the ring magnet are disposed as magnetic pole opposites, a magnetic field line between the center magnet and the ring magnet passes through the diaphragm, and a magnetic pole connection of the center magnet and a magnetic pole connection of the ring magnet pass through the diaphragm.

4. The planar speaker unit of claim 3, wherein the planar coil is distributed in a central area and a ring area surrounding the central area, and an orthographic projection of the ring magnet on the diaphragm is located between the central area and the ring area.

5. The planar speaker unit of claim 1, wherein the first magnet set comprises a center magnet and a plurality of ring magnets, the ring magnets surround the center magnet and are disposed in concentric circles, the center magnet and the ring magnets are disposed as magnetic pole opposites, magnetic field lines between the center magnet and the ring magnets passes through the diaphragm, and a magnetic pole connection of the center magnet and magnetic pole connections of the ring magnets pass through the diaphragm.

6. The planar speaker unit of claim 5, wherein the planar coil is distributed in a central area and a plurality of ring areas, the ring areas surround the central area and are disposed as concentric circles, and an orthographic projection of each of the ring magnets on the diaphragm is located between the central area and one of the ring areas or between two adjacent ring areas.

7. The planar speaker unit of claim 1, wherein a minimum distance between the diaphragm and the first magnet set is less than or equal to 2 mm.

8. The planar speaker unit of claim 1, further comprising a fastener disposed in the housing, wherein an outer edge of the diaphragm is limited between the fastener and the housing.

9. The planar speaker unit of claim 8, wherein the fastener is fixed to the outer edge of the diaphragm.

10. The planar speaker unit of claim 8, wherein the outer edge of the diaphragm can move relative to the fastener and the housing.

11. The planar speaker unit of claim 1, wherein the planar coil is single-turn.

12. The planar speaker unit of claim 1, wherein the planar coil is multi-turn and parallel to each other.

13. The planar speaker unit of claim 1, wherein the housing further has a top wall, and the bottom wall and the top wall are located at two opposite sides of the accommodating space.

14. The planar speaker unit of claim 13, wherein a material of the top wall is a non-magnetic permeable material.

15. The planar speaker unit of claim 13, further comprising a second magnet set disposed on the top wall and located in the accommodating space, wherein the diaphragm is located between the first magnet set and the second magnet set, and a maximum vibration amplitude of the diaphragm is less than a minimum distance between the diaphragm and the second magnet set.

16. The planar speaker unit of claim 1, wherein a material of the substrate is polyimide.

17. The planar speaker unit of claim 1, wherein the planar coil is flatly attached to both sides of the substrate.

18. The planar speaker unit of claim 1, wherein the substrate comprises a coil area, a connection area, and a power supplying area, the connection area is connected between the coil area and the power supplying area, the planar coil is extended from the coil area to the power supplying area via the connection area, two ends of the planar coil are two contacts located in the power supplying area, and the entire planar coil is formed by a homogeneous conductor having a uniform thickness.

19. The planar speaker unit of claim 18, wherein the coil area is located in the accommodating space, the connection area is bent and extended outside the accommodating space, and the power supplying area and the coil area are respectively located at two sides of the bottom wall.

20. The planar speaker unit of claim 1, wherein a material of the bottom wall is a magnetic permeable material.

21. The planar speaker unit of claim 1, wherein the substrate has a plurality of hollow areas surrounding the planar coil.

22. The planar speaker unit of claim 21, further comprising a suspension member disposed on the substrate and across at least one of the hollow areas.

23. The planar speaker unit of claim 1, wherein a center of the bottom wall has a first ventilation hole, the first magnet set has a second ventilation hole, and the first ventilation hole is communicated with the second ventilation hole.

24. The planar speaker unit of claim 1, wherein a thickness of the substrate is greater than or equal to 2 mm.

25. The planar speaker unit of claim 1, wherein the diaphragm further comprises a damping layer covering the substrate and the planar coil to protect the planar coil from oxidation and to absorb a resonance of the diaphragm.

26. The planar speaker unit of claim 25, wherein a material of the damping layer is epoxy resin.

27. The planar speaker unit of claim 1, wherein the diaphragm further comprises a dummy pattern disposed on the substrate except where the planar coil is distributed.

28. The planar speaker unit of claim 27, wherein the dummy pattern and the planar coil are made from the same material and insulated from each other.

29. The planar speaker unit of claim 27, wherein the dummy patter comprises a plurality of strips being distributed radially.
